(19) United States
(12) Patent Application Publication
(10) Pub. No.: US 2007/0295125 A1
(43) Pub. Date: Dec. 27, 2007

(54) Linear Drive

(75) Inventors: Eduard Marthaler, Adetswil (CH); Markus Schmidig, Ibach (CH)

Correspondence Address: THADDIUS J. CARVIS, 102 NORTH KING STREET, LEESBURG, VA, 20176, US

(73) Assignee: BELIMO HOLDING AG, Hinwil (CH)

(21) Appl. No.: 11/574,533

(22) PCT Filed: Aug. 22, 2005
(86) PCT No.: PCT/CH05/00487

§ 371 Date: Mar. 1, 2007

(30) Foreign Application Priority Data
Sep. 2, 2004 (CH) 1448/04

(51) Int. Cl. F16H 19/00

(52) U.S. Cl. 74/89.29

(57) ABSTRACT

The invention relates to an actuator (10) for actuating a device in a linear manner by means of a tangential rod which can be displaced in a longitudinal manner by converting the torque of a motor-driven pinion (32), in particular for a flap or for a valve in the field of heating-ventilation-climatisation (HLK), or fire and smoke protection. According to the invention, a normal threaded rod (24) which can be displaced in the axial direction thereof (L) and which can be cut to an individual length, has a radius (r) which is rotationally secured in the actuator (10). The pinion (32) in connected in a positive fit to at least one drive wheel (36) which is mounted in a freely rotational manner, and an elastic and/or adjustable pressure element (38, 54, 64, 66) which carry out a play-free engagement of drive wheels (36) and the normal threaded rod (24).

The invention relates to an actuator for the linear actuation of a device by means of a tangential rod, which can be longitudinally displaced with conversion of the torque of a motor-driven pinion, in particular for a flap or for a valve in the sector of heating/ventilation/air-conditioning (HVAC), fire and smoke protection.

Electrical actuators for the motorisation of actuators in heating, ventilation and air-conditioning systems (HVAC systems), have been produced for more then 30 years. HVAC actuators ensure an economical volume flow control of gases or liquids, in particular of air and water. As a compact unit, the HVAC actuators generally comprise not only the drive, but also pressure sensors and regulators, all combined in one apparatus.

Ventilation systems are increasingly used in buildings, in particular residential, office, business and industrial buildings, generally combined with fire and smoke protection mechanisms. The volume flow control with pivotable air flaps plays an important part in ventilation systems. The volume flow is measured by a suitable measuring instrument, for example with the NMV-D2M formed as a compact unit of drive, pressure sensor and regulator from Belimo Automation AG, CH-8340 Hinwil, and the measured values are passed to an electronic system.

To move a flap in a ventilation system or a ball cock in a water pipe system, comparatively weak motors have to actuate large-area or large-volume control members. Precise and stable adjustment is only possible with very strong gear reduction. Numerous revolutions of the shaft of the electric motor are necessary to pivot a flap or rotate a ball cock about an acute or right angle. The reduced torque of the motor is converted into a linear movement in an actuator.

DE 10160056 A1 describes a toothed gear drive system which is actuated by an electric motor and is used to actuate a flap of a heating, ventilation and air-conditioning system. The helical axle of a motor transmits the torque to a helical axle in which the teeth of a gearwheel engage. This rotatable second worm has a radial stabilisation unit, which cooperates with a photoelectric sensor mechanism. The entire system is aligned with rotating worm drives, which are not displaceable in the axial direction.

An actuator with two synchronously linearly displaceable toothed racks, which, by a pinion and foul with the pinion, are in positive engagement, in pairs with one another and with the toothed racks, is known from U.S. Pat. No. 5,836,205 A. The toothed racks are produced as a special production and are matched by their teeth to those of the cylindrical gears and the system is correspondingly expensive.

The inventors have set themselves the object of providing an actuator of the type which is mentioned at the outset, which is economical to produce and to operate and can be used in a versatile manner.

The object is achieved according to the invention in that a standard threaded rod which can be individually cut to length and can be displaced in its axial direction, with a radius r, is held so as to be secured against rotation in the actuator, the pinion is in positive engagement with a drive wheel which is also freely rotatably mounted, and a resilient and/or adjustable pressure member is formed, which brings about play-free meshing of drive wheels and the standard threaded rod. Special and developing embodiments of the actuator are the subject of the dependent claims.

A large choice of standard threaded rods with respect to length, diameter, material, tooth shape, pitch and direction of rotation are commercially available. Special threads, such as, for example, double-start threads, can be obtained as mass-produced articles which can be cut to length. Simple standard threaded rods are up to twenty times cheaper than toothed racks which have to be specially produced, for example according to U.S. Pat. No. 5,836,205. Furthermore, conventional toothed racks have a certain length, which is different depending on use and various types have to be kept in stock, which additionally drives up the costs. On the other hand, according to the invention, only standard threaded rods, which do not correspond to the use length, have to be kept in stock and can easily be cut to length at any time in any dimension required.

The drive wheels tangentially displacing the standard threaded rod convert the torque exerted by way of a drive into a linear movement. Expediently, the drive wheels with an integral cylindrical gear are therefore in positive engagement with a drive pinion. Easy fitting can take place when the pitch of the cylindrical gear is n or 1/n times the pitch of the drive wheel and n=1, 2, 3 etc.

The drive wheel expediently has an outer surface which can be precisely rolled on the geometry of the standard threaded rod and is convexly curved. The system therefore has very free movement even when pressing together. Standard threaded rods which are self-locking with nuts are not self-locking with drive wheels according to the invention and are also less sensitive to dirt.

The standard threaded rods which are introduced into the actuator project with respect to the housing or the turned-over end walls of the base plate and on either side penetrate a bore, preferably with play. With a radius r of the standard threaded rod, the bore has a radius r+Δr. The threaded rod is flexibly mounted in the transverse direction in this manner, but has a defined transverse force limitation, which, depending on the use of the actuator, is greater or smaller.

The standard threaded rod may, at both ends, have a detachable and preferably adjustable path limitation, for example in the form of a nut, which is secured with a counternut, a removable split pin with a spring securing means or similar means which is known per se, with a housing or turned-over side walls of the base plate as a stop point.

Securing the standard threaded rod against rotation is of substantial importance. This is implemented most easily in that the standard threaded rod is fastened to the device which is to be displaced in the longitudinal direction and which is generally only longitudinally displaceable but not rotatable. This is expediently implemented in a detachable manner, for example by way of a plate which is rigidly connected to the standard threaded rod or a bracket.

The standard threaded rod which has been cut to length may be flattened at least on the inside at a spacing apart from the end faces in the axial direction, i.e. the region of the end sides of the standard threaded rod advantageously remains unchanged, in this case. In the extreme case, the threaded rod may be halved over the entire length. This may be implemented to facilitate the longitudinal displacing of the pressure member on the threaded rod. Simple pressure rollers with a convex outer side may thus also be universally used, for example.

The pressure member may, as mentioned above, be formed in any manner, also so as to slide, in principle, but preferably so as to roll. In practice, this expediently takes place with at least one pressure roller, preferably with two pressure rollers arranged at a spacing apart. These are formed with an unchanged standard threaded rod, optionally with a concavely peripheral toothed or toothless cylindrical lateral surface. The pressure rollers are preferably arranged opposite a drive wheel. The pressure roller may, however, also be located between two drive wheels.

In practice, the following variants are produced:
one drive wheel, one pressure roller. This embodiment allows an oscillating standard threaded rod. This must be guided by transverse force limitations; as mentioned, this takes place, for example, through bores, but also through longitudinal slots, which limit the movements, in particular the oscillating movements, of the standard threaded rod.
two drive wheels, one pressure roller: the pressure roller may develop an optimal action when it is located in the middle between the drive wheels. This applies correspondingly to a drive wheel and two pressure rollers.
two pairs, arranged at a spacing apart, of a drive wheel and pressure roller. This embodiment, which is used most frequently in practice, basically requires no transverse force limitations.

Obviously, more than two drive wheels and/or pressure rollers can be used, however, the cost/use ratio has to be considered.

According to a further embodiment of the invention, non-resilient pressure rollers can also be used in that identically formed slots are formed in the base and end plate of the actuator, preferably in the region of pressure rollers and/or the drive wheels. Furthermore, the pressure rollers may be formed such that they have a peripheral annular groove, which develops a spring action. Obviously, the individual variants may also be combined with one another if the economy is maintained.

The advantages of the present invention can be summarised as follows:
instead of specific toothed connecting rods or complicated rotating worm gears, exceptionally economical standard threaded rods which can be commercially obtained everywhere can be acquired and simply cut to length in accordance with the use.
the comparatively large tolerance of commercially conventional standard threaded rods is minimised by the pressure of the drive wheels and a higher tensile and pressure loading of the standard threaded rod is made possible.
the combination according to the invention of a standard threaded rod with drive wheels has no self-locking and, if necessary, the standard threaded rod can be introduced or removed manually.
because of the freedom from play, the sensitivity to dirt is also minimised and the continuous cylindrical rolling displaces the dirt.
the number of drive wheels can be varied according to use. A single pair of a drive wheel and a pressure roller produces a cardanic fastening with a large one-dimensional freedom of movement, called oscillation. Two drive wheels allow a larger force transmission with the same flank loading.
Two or more standard threaded rods may also be used per actuator, with corresponding adaptation of the other components.

The invention will be described in more detail with the aid of embodiments, which are shown in the drawings and which are also the subject of dependent claims. In the drawings, schematically:

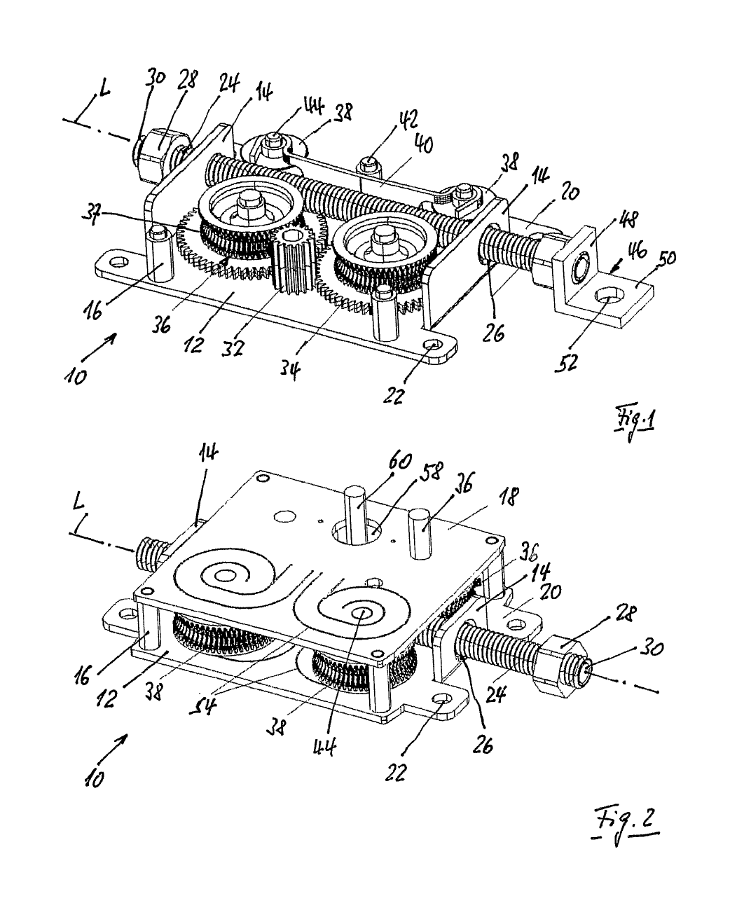

FIG. 1 shows an actuator with a lifted-off cover plate, in a perspective view,

FIG. 2 shows a variant of FIG. 1 with a cover plate,

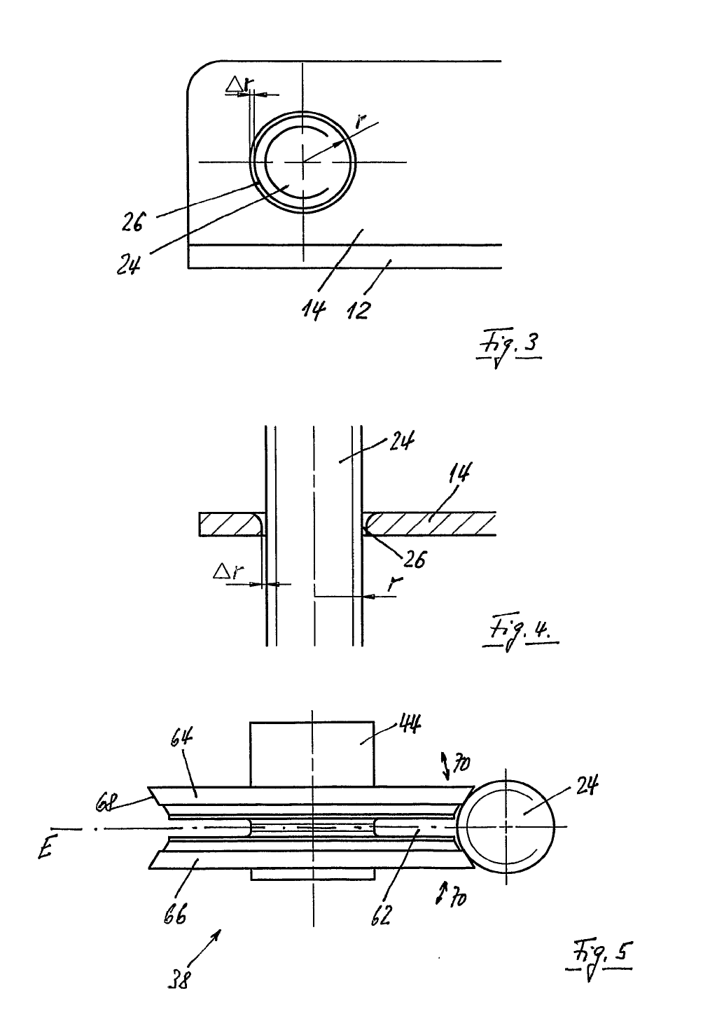

FIG. 3 shows a view of a transverse force limitation,

FIG. 4 shows a view of a resilient pressure roller resting on a standard threaded rod, and

FIG. 5 shows a cut open plan view of FIG. 4.

An actuator 10 according to FIG. 1 comprises a base plate 12, which is substantially rectangular. Two lugs of the base plate 12 consisting of a metal plate are bent over at right angles and form side walls 14 as indicated. A cover plate 18 also consisting of the same metal plate is also fastened by way of support posts 16. Fitting lugs 20 each with a bore 22 are used to fasten the actuator 10 as a whole.

A standard threaded rod 24, which has been cut to length, penetrates with play a respective bore 26, in each case, in the side walls 14 which are bent over at a right angle and it can be freely displaced in the axial direction L, its longitudinal direction. The bore 26 forms a transverse force limitation.

Two nuts which are arranged in the region of the end 30, on the end face, of the standard threaded rod 24 form a path limitation 28 on either side in the axial direction L, for example a respective counternut, not shown, fixes the nuts. The two side walls 14 form a stop for the path limitations 28, which can also be formed, as mentioned, as a spring-secured split pin.

A motor-driven pinion 32 is mounted in the base plate 12 and cover plate 18 and engages in a positive manner in the projecting cylindrical gear 34 of two drive wheels 36, which are freely rotatably mounted in the base plate 12 and cover plate 18.

The standard threaded rod 24 is pressed by two pressure rollers 38 without play onto the drive wheels 36 with a concavely curved, toothed outer surface 37. This takes place by means of an oscillating leaf spring 40, which is placed so as to be pivotable on a bolt 42. The two ends of the leaf spring 40 wind round the shafts 44 of the pressure rollers 38 and hold them. In the normal position, the leaf spring 40 is slightly tensioned.

An anti-rotation device 46 of the standard threaded rod 24 is angular. A leg 48 of the anti-rotation device 46 is rigidly connected to the standard threaded rod 24 and the other leg 50 has a bore 52 which is used for detachable fastening to a device which can be displaced in a translatory manner and is not rotatable.

FIG. 2 shows an actuator 10 with a fitted cover plate 18. In this view, the pressure rollers 38 which can be freely rotated with their rigid shaft 44 can be seen from the front. Instead of a leaf spring 40 (FIG. 1), slots 54 are provided as the pressure member in the base plate 12 and cover plate 18 and allow a spring action when the pressure rollers 38 are placed on the standard threaded rod 24. The slots 54 are arranged precisely congruently in the two plates 12, 18. The pressure rollers 38 are in the present case configured in a form which corresponds geometrically to the drive wheels 36, also with respect to the teeth.

According to FIG. 2, only a single drive wheel 36 is formed, which is located opposite one of the two pressure rollers 38. The shaft 56, which is rigidly connected to the drive wheel 36, projects over the cover plate 18. This is also the case for the drive shaft 60 of the pinion 32, which penetrates the bore 58 with play (FIG. 2).

The anti-rotation device 46 is not shown in FIG. 2 and is in turn implemented by means of the device which can be displaced in a translatory manner, the standard threaded rod 24 being screwed into an interior thread and fixed with the path limitation 28 as a counternut.

FIGS. 3 and 4 show a view of a side wall 14 turned over from the base plate 12, with a radial section of the standard threaded rod 24. The standard threaded rod 24 with the radius r coaxially penetrates, with play, the bore 26 at a spacing Δr. If, in a modification of FIG. 2, only its right-hand pressure roller 38 is configured, the bore 26 forms a transverse force limitation for an oscillating movement of the standard threaded rod 24.

FIG. 5 shows a specially formed pressure roller 38, which rests on the standard threaded rod 24 which is shown in radial section. The shaft 38 is mirror-symmetrically formed with respect to a plane of symmetry E. It has an annular groove 62, which extends into the region of the shaft 44. Two disc-shaped legs 64, 66 are formed thereby which form a concavely peripheral outer face 68. When pressing an integral pressure roller 38 onto the standard threaded rod 24, the two disc-shaped legs 64, 66 spread apart elastically depending on the pressure force, which is shown by double arrows 70. The pressure roller 38 may also be formed in two or more parts. In the case of a pressure roller 38 which is divided into two along the plane E, the two halves are pressed together with spring force. On pressure, the holding forces are overcome and the legs 64, 66 open elastically. FIG. 4 shows further variants of a resilient pressure member.

The pressure members shown in FIGS. 1, 2 and 5 which are in the form of two resilient pressure rollers 38, slots 54 and resilient disc-shaped legs 64, 66 can be formed individually or can be combined with one another.

The drive rollers 36/end toothed wheels 34 and/or pressure rollers 38 consist of conventional materials, for example steel or plastics material, depending on the requirements made of them, such as, for example, loading, service life, free movement and processing.

1. Actuator (10) for the linear actuation of a device by means of a tangential rod, which can be longitudinally displaced with conversion of the torque of a motor-driven pinion (32), in particular for a flap or for a valve in the sector of heating/ventilation/air-conditioning (HVAC), fire and smoke protection, characterised in that a standard thread rod (24), which can be individually cut to length and can be displaced in its axial direction (L), with a radius (r), is held so as to be secured against rotation in the actuator (10), the pinion (32) is in positive engagement with at least one freely rotatably mounted drive wheel (36) and a resilient and/or adjustable pressure member (38, 54, 64, 66) is formed, which brings about play-free meshing of drive wheels (36) and the standard threaded rod (24).

2. Actuator (10) according to claim 1, characterised in that the drive wheel (36) has an outer surface (37) which rolls precisely on the geometry of the standard threaded rod (24) and is peripherally concavely curved.

3. Actuator (10) according to claim 1 or 2, characterised in that the standard threaded rod (24) which projects on either side has, on at least one end face (30), a transverse force limitation, preferably in the form of a bore (26) with a larger radius (r+Δr) than the standard threaded rod (24) in the housing or in a turned-over end wall (14) of the base plate (12) of the actuator (10).

4. Actuator (10) according to at least any one of claims 1 to 3, characterised in that the standard threaded rod (24) has a path limitation (28) which is effective on either side in the axial direction (L), in particular in the form of locked nuts or spring-secured split pins, which strike against the turned-over end wall (14) of the base plate (12) or on the housing.

5. Actuator (10) according to any one of claims 1 to 4, characterised in that an angle-shaped or plate-shaped anti-rotation device (46) is formed, which is detachably connected to the device that can be displaced in a translatory manner.

6. Actuator (10) according to any one of claims 1 to 5, characterised in that the resilient pressure member is in the form of at least one pressure roller (38) with teeth extending in a concavely curved manner or with a concave, flat or convex peripheral outer surface formed without teeth, the pressure rollers (38) preferably being arranged opposite the drive wheels.

7. Actuator (10) according to any one of claims 1 to 6, characterised in that one or two drive rollers (36) and pressure rollers (38) oppose one another pairwise in each case, two pressure rollers (38) preferably having a common leaf spring (48) suspended in an oscillating manner.

8. Actuator (10) according to any one of claims 1 to 7, characterised in that identically formed slots (54) in the base plate (12) and cover plate (18), preferably in the region of the pressure rollers (38) and/or drive wheels (36), form the pressure member.

9. Actuator (10) according to any one of claims 1 to 8, characterised in that pressure rollers (38) are arranged as pressure members and have an annular groove (62) and two disc-shaped elastic legs (64, 66) limiting the groove, which spread apart in the event of pressure on the standard threaded rod (24) and/or open, in a multi-part configuration, by elastically overcoming the holding forces and thus develop a spring action.

10. Actuator (10) according to any one of claims 1 to 9, characterised in that the drive wheels (36) are integral with a cylindrical gear (34), and are in positive engagement with a pinion (32), the pitch of the cylindrical gear (34) making up n or 1/n times the pitch of the drive wheel (36) and n=1, 2, 3 etc.
